(19) United States
(12) Patent Application Publication
(10) Pub. No.: US 2023/0157321 A1
(43) Pub. Date: May 25, 2023

(54) AQUATIC ANIMAL HEALTH AND WELLNESS FEED PRODUCT

(71) Applicant: Archer Daniels Midland Company, Decatur, IL (US)

(72) Inventors: Stephanie S. Block, Bement, IL (US); Perry H. Doane, Decatur, IN (US); John Bowzer, Mt. Zion, IL (US)

(21) Appl. No.: 17/997,725

(22) PCT Filed: Apr. 30, 2021
(86) PCT No.: PCT/US21/30296

§ 371 Date: Nov. 1, 2022

Related U.S. Application Data
(60) Provisional application No. 63/019,159, filed on May 1, 2020.

(51) Int. Cl. A23K 50/80; A23K 10/30; A23K 20/163; A23K 20/126; A23K 20/111; A23K 10/12

(52) U.S. Cl. CPC A23K 50/80; A23K 10/30; A23K 20/163; A23K 20/126; A23K 20/111; A23K 10/12

(57) ABSTRACT

Methods of preventing/treating ectoparasite infections in fish are disclosed. In an aspect, a method comprises mixing at least one of glucosamine containing product, a lactone containing product, a capsaicin or capsaicinoid containing product, an essential oil, or a combination thereof, with a fish feed ingredient, thus producing a fish food. The method comprises feeding the fish food to the fish such that the ectoparasite (such as sea lice) infection is treated, reduced and/or prevented in the fish. In an aspect, the method comprises mixing a botanical plant extract containing capsaicin, capsaicinoids, vanilloids, or lactone members of the germanocrolide, guianolide or phthalide lactone groups, chosen from at least one of the Apiaceae, Fabaceae, Solanaceae, Asteraceae, and Zingeberaceae family groups, with the fish food.

### BACKGROUND OF THE INVENTION

Aquatic species have unique farming requirements in that the feed and the environment must be managed. Parasitic organisms, such as trematodes, nematodes, cestodes, protozoans, amoebocytes, and copepods, from the environment are common in aquaculture operations and have a significant adverse impact on the profitability of the farm. The worldwide production of aquatic animals using aquaculture technologies is limited due to the adverse impact of parasitic organisms. Sea lice are naturally occurring ectoparasitic copepods that cause significant economic impact to the salmon industry. When sea lice encounter salmon, in particular Atlantic Salmon, the sea lice will attach to the salmon, resulting in an infestation. The resulting infestation can cause growth impairment, disease, and lead to death. In addition to morbidity and mortality concerns, the sea lice attachment lesions are unsightly and lead to the rejection of fish by fish processors and resulting economic loss. Growth impairment and losses due to salmon death from sea lice infection are a clear cause of lost income. In the case of salmon, strict standards based on country and season exist for the allowable concentration of parasitic organisms such as sea lice. Once the threshold for sea lice is reached (e.g., 0.1-3.0 ovigerous females), treatment of some form is required. The additional cost of treatment further impacts the profitability of the farm.

To prevent growth impairment and the loss of saleable fish, salmon producers must resort to expensive methods in effort to control sea lice infestations. Fish farmers have employed a variety of technologies to discourage, divert, and dislodge sea lice from salmon. The use of synthetic chemicals such as ivermectin may be used to treat fish, however, the use of pharmaceutical toxins raises concerns over environmental pollution and unintended targets. The use of heterocyclic radicals with and without organic salt conjugation of alkane carboxylic acids has been disclosed as a method of treating sea lice infestation in U.S. Pat. No. 6,054,454.

The use of mechanical dislodging of sea lice is occasionally employed, wherein fish are moved through a system that can spray, scrape or otherwise cause the removal of attached sea lice. This method has some effectiveness but increases the amount of handling stress on the fish, resulting in reduced fish growth and death losses. Further, mechanical dislodging of sea lice requires particular equipment and a large amount of labor to employ.

The use of feed additives to help support animal health and wellness is documented in the animal production space. Animal feeds are frequently formulated with vitamins and minerals that help the immune system during periods of stress. Purified chemicals are also used to combat disease and improve animal performance. Despite the increased interest in natural alternatives to these chemicals, there are minimal solutions available from plant sources that provide health and wellness benefits or that can be used in place of chemicals to prevent or deter disease. Manufacture of aquaculture feeds commonly exposes materials to heat and pressure creating an additional challenge for delivery of solution within the feed matrix. Many plant extracts contain essential oils that are volatile or unstable under the heat and moisture stress of manufacturing conditions, which also challenge application of probiotic and prebiotic approaches.

Non-pharmaceutical ingredients have been employed with minimal success. The use of mannanoligosaccharides (MOS) and beta-glucan sources have been applied with variable impact. The inconsistency of efficacy can likely be attributed to dietary inclusion, variation in the structural components, and timing of feeding. These aspects can greatly affect the success of these immunostimulating substances against ectoparasites. Inconsistent results are demonstrated in an article by Covello et al., “Effects of orally administered immunostimulants on inflammatory gene expression and sea lice (Lepeophtheirus salmonis) burdens on Atlantic salmon (Salmo salar),” Aquaculture 366-367 (2012) 9-16. Covello et al. reported that the beta-glucan product (ProVale™) had no success on sea lice infection while a combination of AllBrew and NuPro which contains beta-glucans and MOS did reduce sea lice infection. Conversely, in another study by Refstie et al., “Effects of dietary yeast cell wall β-glucans and MOS on performance, gut health, and salmon lice resistance in Atlantic salmon (Salmo salar) fed sunflower and soybean meal,” Aquaculture 305 (2010) 109-116, adding beta-glucan to the diet reduced sea lice-infested fish but adding MOS to the diet did not affect lice infestation. Given these results, the use of MOS and beta-glucans for sea lice mitigation can have highly variable impacts and may not be the active components of the ingredients identified. Plant extracts have had similar variable impacts on sea lice infections due to the diverse nature of ingredients, variable composition dependent on process and geographical region, and the relative instability of these ingredients in comparison to pharmaceutical ingredients. Collectively, the high variability in quality, timing, and dose of these ingredients has limited the success for control of sea lice infections in Atlantic salmon.

US 2012/0202770 relates to an animal feed composition comprising protein from the family of Fabaceae and protein from the family Asteraceae and to such formulations which also comprise glucan and/or mannan. The reference states that such feeds find utility in stabilizing or increasing weight in a target animal, particularly fish, as well as in treating ectoparasitic infections, diarrhea and bowel disease. The composition presented in the reference teaches towards a combination of improved protein content and an entrained mannan and or glucan content. This approach is distinct from extraction of other plant fractions or chemistry intended to develop a “plant extract” or feed supplement directed towards nutrition separate from protein requirements of the species being fed. As would be understood in practice, the level or extent of extraction desired is variable and largely depends on the constraints imposed by the logistics of feed formulation and delivery to the animal.

A reference that discloses a study to improve fish life is “Dietary Yeast Cell Wall Extract Alters the Proteome of the Skin Mucous Barrier in Atlantic Salmon (Salmo salar): Increased Abundance and Expression of a Calreticulin-Like Protein,” by Micallef G., et al. PLOS ONE, 2017 Jan. 3, 12(1), E0169075. The reference discloses that a calreticulin-like protein increased in abundance at both the protein and transcript level in response to dietary yeast cell wall extract. The reference discloses that the calreticulin-like protein was identified as a possible biomarker for yeast-derived functional feeds since it showed the most consistent change in expression in both the mucus proteome and skin transcriptome. The reference discloses that discovery of such a biomarker is expected to quicken the pace of research in the application of yeast cell wall extracts. The reference discloses that the yeast cell wall extract (YCW) used in the study contained >20% w/v mannanoligosaccharide (MOS) with the remainder mainly comprised of proteinaceous material, but also other cell wall fractions including β-glucans and cellular constituents such as nucleotides. The reference discloses that alternatively the main dietary constituents of MOS and FOS, which are polymers of the mannan and fructose sugars respectively, can be substrates for bacterial growth within the gut, thereby selectively modifying the microbial composition, which in turn may have elicited the skin mucus response.

The article of Micallef et al. 2017 above is primarily focused on the disclosure of biomarkers and biomarker utility as a research tool for evaluating efficacy of diet or other intervention on fish health. The inclusion of MOS and FOS fractions are utilized to evaluate the correlation between fish health and biomarkers but recognizes both that the additives included fractions other than MOS or FOS and that the mechanism responsible for the correlation presented could be secondary and relating to digestive and microbial metabolism. Two difficulties emerge related to these topics: first, microbial cells also contain polymers based on glucosamine which have considerable complexity in structural substitution and linkage within biological fractions (such as, but not limited to, cellular wall). Muramic acid and chitin are examples within these fractions present in the literature. Second, content of this fraction within a microbial mass can be manipulated by supplementation and environment (Engelking et al., “Shifts in amino sugar and ergosterol contents after addition of sucrose and cellulose to soil,” Soil Biology and Biochemistry 39 (2007) 2111-2118), and further, the inclusion within a complex matrix such as a prepared feed or animal digesta is analytically complex. An article of Moriarty, “Improved method of using muramic acid to estimate biomass of bacteria in sediments,” Oecologia 26 (1977) 317-323, provides estimates of cell composition for a range of microbial organisms and proposes an approach of mathematical estimation of microbial content across ocean sediment. The article of Jost et al., “Determination of microbial biomass and fungal and bacterial distribution in cattle feces,” Soil Biology and Biochemistry 43 (2011) 1237-1244, discloses an application of this approach (to soils) with an additional set of compositional data and inclusion of further compounds to support the distinction between microbial classes.

It would be beneficial to have methods that do not have the disadvantages and drawbacks of conventional methods. For example, it would be beneficial to have a feed supplement that can be easily made from widely available sources while achieving a high-quality level and keeping that high-quality level constant. The ability to deliver a product to reduce the impact of sea lice on salmon without the use of pharmaceuticals would be beneficial. In addition, an in-feed solution that can be incorporated into the primary feed and remain active through extrusion of the primary feed would be beneficial. Such an in-feed solution would allow fish feed manufacturers to save money by eliminating additional processing steps such as top-coating the primary feed with a feed supplement. The use of active ingredients in a matrix of the animal feed also reduces the amount of product that may leach into the aquatic environment from the feed while it is immersed in water prior to consumption by the fish. It would be beneficial to have non-pharmaceutical methods to reduce the parasitic impact on fish using natural ingredients applied within the feed prior to pelleting or extrusion.

### BRIEF SUMMARY OF THE INVENTION

The present invention provides advantages over conventional methods and products. In an aspect, a method comprises mixing at least one of a glucosamine containing product, a lactone containing product, a capsaicin or capsaicinoid containing product, an essential oil, or a combination thereof, with a fish feed ingredient, thus producing a fish food. The method comprises feeding the fish food to the fish such that the ectoparasite (such as sea lice) infection is treated, reduced and/or prevented in the fish.

In an aspect, a method of preventing/treating ectoparasite infections in fish comprises mixing a botanical plant extract having a sesquiterpene lactone with one or more fish feed ingredients, thus producing a fish food, and feeding the fish food to the fish such that the ectoparasite infection is treated, reduced, or prevented in the fish. In an aspect, the botanical plant extract is chosen from at least one of the Apiaceae, Fabaceae, Solanaceae, and Asteraceae, or Zingeberaceae family groups. It has been discovered that by using a botanical plant extract as a fish feed supplement, ectoparasites such as sea lice infestation can be prevented or treated in fish. Such a botanical plant extract can be produced from widely available sources while achieving a high-quality level and keeping that high-quality level constant.

In an aspect, a method of preventing/treating ectoparasite infections in fish comprises mixing a glucosamine containing product with a fish feed ingredient, thus producing a fish food. The method further comprises feeding the fish food such that ectoparasites (for example sea lice) infestation, is treated, reduced or prevented in the fish. In an aspect, glucosamine containing product is a microbial biomass. In an embodiment, the microbial biomass is a cell mass of at least one of a Pichia origin, a Saccharomyces origin, an E. coli origin, or a Corynebacteria origin. In an aspect, the fish is salmon.

In an aspect, a method of preventing and/or treating ectoparasite or sea lice infections in fish comprises (a) mixing a capsaicin or vanilloid containing product, an essential oil selected to comprise a sesquiterpene lactone from the group of germanocrolide, guianolide or phthalide lactones, and a cell mass of a Pichia origin, a Saccharomyces origin, an E. coli origin, or a Corynebacteria origin, to form a fish feed supplement, (b) mixing the fish feed supplement with a fish feed ingredient, thus producing a fish feed, and (c) feeding the fish feed to the fish such that a sea lice infection is treated or prevented in the fish. In an aspect, fish are fed the fish feed for a period of at least six weeks.

In an aspect, a fish feed composition comprises 0.0002-0.002% by weight capsaicinoids, 0.001-0.01% by weight an essential oil, 0.2-1.0% by weight a cell mass, 0.001-0.01% by weight glucosamine, and the remainder fish feed ingredients. In an aspect, the cell mass is chosen from at least one of Pichia origin, a Saccharomyces origin, an E. coli origin, or a Corynebacteria origin. In a preferred embodiment, a fish feed composition comprises 0.0004-0.001% by weight capsaicinoids, 0.0015-0.006% by weight an essential oil, 0.3-0.8% by weight a cell mass chosen from at least one of Pichia origin, a Saccharomyces origin, an E. coli origin, or a Corynebacteria origin providing 0.003-0.008% by weight acid hydrolysable glucosamine, and the remainder fish feed ingredients. In an even more preferred embodiment, the composition comprises 0.0008% by weight capsaicinoids, 0.0025% by weight an essential oil, 0.6% by weight a cell mass chosen from at least one of Pichia origin, a Pichia origin, a Saccharomyces origin, an E. coli origin, or a Corynebacteria origin providing 0.0055% by weight acid hydrolyzable glucosamine, and the remainder fish feed ingredients.

These and other aspects, embodiments, and associated advantages will become apparent from the following Detailed Description.

### DETAILED DESCRIPTION OF PREFERRED EMBODIMENT

It has been discovered that by using a botanical plant extract as a fish feed supplement, ectoparasites such as sea lice infestation can be prevented or treated in fish. Such a botanical plant extract can be produced from widely available sources while achieving a high-quality level and keeping that high-quality level constant. The present invention provides a method of preventing and/or treating sea lice infections in fish comprises mixing a botanical plant extract with a fish feed ingredient, thus producing a fish feed, and feeding the fish feed to the fish such that a sea lice infection is treated or prevented in the fish. As used herein, “botanical extract” means a material substantively enhanced in the chemical profile characteristic of the original plant species which may be considered an essence, flavor, essential oil, resin etc. In an aspect, the botanical plant extract is selected for content of a sesquiterpene lactone. In an aspect, the botanical extract derived from but not limited to a botanical family selected from the group consisting of Apiaceae, Fabaceae, Solanaceae, and Asteraceae, and combinations thereof. In an aspect, it may also be understood, when of sufficient natural content, a separated plant part such as flower, stamen, leaf, fruit pulp, seed or seed hull etc. may serve in application as equivalent to a plant extract.

In an aspect, a method of preventing and/or treating sea lice infections in fish comprises (1) mixing a capsaicin containing product, a botanical extract selected for content of sesquiterpene lactone within the classes of germanocrolide, guianolide or phthalide lactones, and a microbial biomass selected from the group consisting of a Pichia origin, a Saccharomyces origin, an E. coli origin, or a Corynebacteria origin, to form a fish feed supplement, (2) mixing the fish feed supplement with a fish feed ingredient, thus producing a fish feed, and (3) feeding the fish feed to the fish such that a sea lice infection is treated or prevented in the fish. In an embodiment, the botanical extract is an extract of a plant leaf, sap or seed, e.g., a lettuce or celery extract, and the microbial biomass is of a Pichia origin.

In an aspect, a fish feed composition comprises 0.0002-0.002% by weight capsaicinoids, 0.001-0.01% by weight an essential oil, 0.2-1.0% by weight a cell mass of Pichia origin, a Saccharomyces origin, an E. coli origin, or a Corynebacteria origin, providing 0.001-0.01% acid hydrolysable glucosamine and the remainder a fish feed ingredient. Preferably, the composition comprises 0.0004-0.001% by weight capsaicinoids, 0.0015-0.006% by weight an essential oil, 0.3-0.8% by weight a cell mass of Pichia origin, a Saccharomyces origin, an E. coli origin, or a Corynebacteria origin, providing 0.003-0.008% acid hydrolysable glucosamine and the remainder a fish feed ingredient. In a preferred embodiment, the composition comprises 0.0008% by weight a capsaicin, 0.0025% by weight an essential oil, 0.6% by weight a cell mass chosen from at least one of Pichia origin, a Saccharomyces origin, an E. coli origin, or a Corynebacteria origin providing 0.0055% acid hydrolysable glucosamine, and the remainder a fish feed ingredient. In an embodiment, the essential oil is a seed oil, e.g., celery seed or lettuce oil.

In an embodiment, the composition may be a cell mass of a Pichia origin, a Saccharomyces origin, an E. coli origin, or a Corynebacteria origin.

In an embodiment, the method may comprise mixing fish food with at least one botanical plant extract chosen from a capsaicin containing product, a celery extract, and a lettuce extract. In an aspect, the fish is salmon.

Aspects of the present invention can be characterized in several ways: (1) by plant species; (2) by plant chemistry; (3) by microbial biomass; and (4) by combination of botanical and microbial sources.

By Plant Species-In an aspect, a method of improving heath or performance of an aquatic animal comprises mixing at least one botanical plant extract in an aquatic animal feed and providing the composite feed ingredient composition to an aquatic animal. As a source of plant secondary compounds, the botanical plant extract is distinguishable from a proteinaceous extract, isolate or concentrate wherein the main nutritive ingredient is protein. The at least one botanical plant extract may be derived from members of the botanical families Apiaceae, Fabaceae, Solanaceae, and Asteraceae. In an embodiment, the at least one botanical plant extract is chosen from a member of the Capsicum genus, a member of the Apiacease family, and a member of the Asteraceae family, and combinations thereof. In an embodiment, the method may comprise mixing least two (2) plant extracts or essential oils chosen from an extract or essential oil derived from a member of the Capsicum genus, a member of the Apiaceae family, and a member of the Asteraceae family. In an aspect, a composition comprises at least one botanical plant extract or essential oil chosen from an extract or essential oil derived from a member of the Capsicum genus, a member of the Apium genus, and a member of the Lactuca genus.

In an aspect, a method comprises mixing with fish food at least one botanical plant extract or essential oil in an aquatic animal feed, wherein the at least one botanical plant extract or essential oil is chosen from a capsaicin containing product, and a celery extract, and a lettuce extract. In an aspect, the at least one botanical plant extract or essential oil is chosen from the Zingeberaceae family, a member of the Capsicum genus, a member of the Apiaceae family, and a member of the Asteraceae family.

By Plant Chemistry—In an aspect, a method of reducing the number of ectoparasites in an aquatic animal comprises mixing a botanical source containing capsaicin, dihydrocapsaicin, capsaicinoids, vanilloids, nonivamide, or sesquiterpene lactone, and combinations thereof, in an aquatic animal feed to produce a composite feed ingredient composition, and providing the composite feed ingredient composition to an aquatic animal. The composite feed ingredient composition may include water, ethanol or other extract, a macerated plant product, a ground herb, spice or plant part, an encapsulated or coated botanical plant extract.

In an embodiment, the composition may comprise a mixture of botanical plant sources, extracts or essential oils, or combination thereof, wherein such materials are selected from the group consisting of capsaicin, capsacinoids, germanocrolide, guianolide or phthalide lactones.

In an embodiment, the composition may comprise a mixture of botanical plant sources, extracts or essential oils, or combination thereof, wherein such materials are selected from the group consisting of capsaicin, capsacinoids and metabolic relatives and materials containing components selected from the group, germanocrolide, guianolide or phthalide lactones.

By Microbial Biomass—In an aspect, a method of reducing the number of ectoparasites in an aquatic animal comprises mixing a separated microbial biomass in an aquatic animal feed to form a fish feed, the microbial biomass physically separated from a fluid portion of the growth matrix, the separated microbial biomass derived from a member of the microbial genus chosen from Schizosaccharomyces, Saccharomyces, Pichia, Aspergillus, Penicillium, Rhizopus, Mucor, Trichoderma, Corynebacterium, and Escherichia, and providing the composite feed ingredient composition to an aquatic animal.

The growth matrix referenced herein may be an aqueous solution or aqueous semi-solid formulated to supply carbohydrate, nitrogen, mineral and growth factor requirements of the organism being propagated. As will be understood by those skilled in the art having the benefit of the present disclosure, in application the balance and profile of ingredients (sugars, protein extracts, ammonia, etc.) or process byproducts such as corn steep liquor will depend on relative purity of carbohydrate such as sugars and contribution of protein and minerals as compared to desired nutrient balance.

In an aspect, a method comprises mixing a microbial source of a polymeric form of a substituted glucosamine in an aquatic animal feed, wherein the microbial source is a separated microbial biomass, the microbial biomass physically separated from a fluid portion of the growth matrix, and providing the composite feed ingredient composition to an aquatic animal. There are various mechanical ways a biomass is concentrated prior to drying that would fall into these general categories. These methods include filtration, compression, sedimentation, centrifugation, flocculation, and similar methods. In an embodiment, the microbial biomass is physically separated from a fluid portion of the growth matrix according to any of the methods selected from the group consisting of compression, filtration, centrifugation, and sedimentation, and combinations thereof.

In an aspect, a method comprises mixing a microbial source of a polymeric form of a substituted glucosamine in an aquatic animal feed to form a composite feed composition and feeding the composite feed composition to an aquatic animal, wherein the microbial source is a separated microbial biomass, the microbial biomass physically separated from a fluid portion of the growth matrix, wherein the microbial biomass is an organic acid or combination of organics acids with at least two (2) carbonyl groups, wherein the separated microbial biomass has between 1 and 15% of organic acids with at least two (2) carbonyl groups.

In an embodiment, the microbial biomass further comprises an organic acid or combination of organics acids from the group, citric acid, glutamate, gluconic acid, succinate, fumaric acid, pyruvate, malic acid, pimelic acid, malonic acid, glutarate, wherein the separated microbial biomass has between 1 and 15% of the group of organic acids.

The substituted polymeric glucosamine can be expected to incorporate but not be limited to the content of structural muramic acid or chitin. As presented in Moriarty “Improved method of using muramic acid to estimate biomass of bacteria in sediments,” Oecologia 26 (1977) 317-323, gram positive bacteria contain about 2% muramic acid relative to 45% carbon and 40 mg muramic/g carbon, therefore, provision of about 0.03% biomass provides about 5 mg/kg of substituted polymeric glucosamine. Conversion to a feed inclusion results in an embodiment wherein the microbial biomass has a polymeric substituted glucosamine of at least 5 mg per kg dry weight to 5 g per kg dry weight of the composite feed ingredient composition to form a composite feed composition. Alternately, chitin at 20% of a fungal cell wall and, cell wall contributing 50% of biomass results in an estimate for substituted polymeric glucosamine of 3 g/kg final feed at a 3% inclusion in feed.

Those skilled in the art having the benefit of the present disclosure will recognize that combination of botanical and microbial sources as described above may be used to provide fish feed supplement to reduce the number of ectoparasites in an aquatic animal. In an aspect, a method of reducing the number of ectoparasites in an aquatic animal comprises mixing a botanical plant extract and microbial biomass in an aquatic animal feed to form a fish feed, and feeding an aquatic animal with the fish feed, wherein the botanical plant extract is derived from a member of the Capsicum genus or members of the botanical families Zingeberaceae, Apiaceae or Asteraceae families. In an embodiment, the microbial biomass is a separated microbial biomass, the microbial biomass physically separated from a fluid portion of the growth matrix, the microbial biomass providing a polymeric substituted glucosamine, the separated microbial biomass containing between 1 and 15% of organic acids with at least two (2) carbonyl groups, and providing the composite composition to an aquatic animal.

In an aspect, a method of reducing the number of ectoparasites in an aquatic animal comprises mixing a botanical plant extract and microbial biomass in an aquatic animal feed to form a fish feed, and feeding an aquatic animal with the fish feed, wherein the botanical plant extract is derived from a member of the Capsicum genus or members of the botanical families Zingeberaceae, Apiaceae or Asteraceae families. In an embodiment, the microbial biomass is a separated microbial biomass, the microbial biomass physically separated from a fluid portion of the growth matrix, the microbial biomass providing a polymeric substituted glucosamine at least 5 mg per kg dry weight to 5 g per kg dry weight of the composite feed ingredient composition and providing the composite composition to an aquatic animal.

In an embodiment, the botanical plant extract or essential oil is selected from the group consisting of an extract or essential oil derived from a member of the Capsicum genus and a member of the Apium or Lactuca genus.

In an embodiment, the separated microbial biomass is selected from the group consisting of Schizosaccharomyces, Saccharomyces, Pichia, Rhizopus or Corynebacterium genus, and combinations thereof.

Those skilled in the art having the benefit of the present disclosure will recognize the fish feed supplement as disclosed herein may be added to the aquatic animal feed in feed manufacture prior to extrusion or after extrusion.

In an aspect, the methods disclosed herein are useful in that they improve the health or performance of an aquatic animal by reducing the number of ectoparasites, wherein the ectoparasite is a copepod, and the aquatic animal is a fish. In an embodiment, the fish is of the family Salmonidae.

The following example further illustrates the benefits of the present invention.

### Example 1

Salmon were fed three experimental diets for 6 weeks. At the end of 6 weeks the fish were exposed to juvenile sea lice. The number of sea lice attached to the fish was counted at the end of the experiment. Two of the experimental diets resulted in a reduction in the number of sea lice that were adhered to the surface of the fish. The control diet contained standard fish feed ingredients such as fish meal, wheat flour, fish oil, poultry by-product meal, corn protein concentrate, squid meal, spirulina, soy lecithin, astaxanthin, amino acid supplementation, choline chloride, vitamin premix, and mineral premix. Diet 1 contained these same ingredients as the control diet, and further included dried whole Pichia guilliermondii yeast at 0.6% by weight of the diet. Diet 2 contained the same ingredients as the control diet, and further included dried whole Pichia guilliermondii yeast at 0.6% by weight, and 0.01% by weight encapsulated capsicum, and 0.01% by weight celery seed oil of the diet. The dried whole Pichia guilliermondii yeast used in this example was provided by ADM Animal Nutrition under the brand name CitriStim® [550310].

The table below shows that Diet 1 and Diet 2 in accordance with aspects of the invention outperformed the control diet. Diet 1 had an average number of lice of 19.39, which was 16.4% lower than the average number of lice of the control diet, i.e., 23.20. Diet 1 had an average lice density of 0.32, which was 23.8% lower than the average lice density of the control diet, i.e., 0.42.

Diet 2 had an average number of lice of 16.58, which was 28.5% lower than the average number of lice of the control diet, i.e., 23.20. Diet 2 had an average lice density of 0.27, which was 35.7% lower than the average lice density of the control diet, i.e., 0.42.

TABLE

| | Average of | StdDev of | Average of | StdDev of |
|---|---|---|---|---|
| Diet | # of Lice | # of Lice | Lice Density | Lice Density |
| Diet 1 | 19.39 | 9.28 | 0.32 | 0.15 |
| Control | 23.20 | 11.63 | 0.42 | 0.27 |
| Diet 2 | 16.58 | 8.04 | 0.27 | 0.14 |
| Grand Total | 20.18 | 10.23 | 0.35 | 0.21 |

| | | |
|---|---|---|
| P value | 0.0823 | 0.0455 |

Prior to the present disclosure, conventional non-pharmaceutical feed ingredients have not been shown to be effective in reducing the concentration of sea lice on salmon. The use of feeds as disclosed in the present disclosure to improve the ability of fish to withstand potential sea lice infection is surprising, and a breakthrough in sea lice management. The present invention's method of treatment with natural ingredients in feed is less aggressive than conventional treatments because it does not involve handling stress to fish and/or release of potentially harmful pharmaceutical ingredients into the environment that occur with conventional treatments. This less aggressive approach of the present invention to reduce the concentration of sea lice on salmon is of value to be used as a method to eliminate or reduce the need for conventional aggressive treatments (i.e., mechanical removal, bath treatments, or pharmaceutical solutions which cause stress and or environmental impacts) to maintain the health of the treated animal prior to market. This reduces the administration of aggressive technologies. The less aggressive method of the present invention may also be used in conjunction with additional technologies for maximal economic benefit.

Content of glucosamine was determined for a sample of Pichia guilliermondii biomass. Content of free glucosamine (unbound) was below the limit of detection of the methods used. After acid hydrolysis, glucosamine content was between 0.9 and 0.94% on an as is basis (approx. 10% moisture). The method used was not quantitative for the substituted forms of glucosamine, but post hydrolysis the substituted forms are estimated to be approximately equivalent in content to glucosamine. As a result, the content of original glucosamine polymer would be about 2% of dry weight of the microbial biomass.

In an embodiment, the compositions described herein may be applied through the animal feed, as a nutritional feed ingredient, and is a non-pharmaceutical. The compositions described herein are heat-stable, thereby allowing the compositions to be effective even when subjected to the high heat and pressure of feed extrusion. Feed was formed by mixing all of the feed ingredients into a dry meal form and then extruded using a conventional extruder typically used for aqua-feed production. Feed was then placed into an air dryer to remove excess moisture and create a stable feed with a moisture content of lower than 10%. In some cases, additional fat is added to the pellet through the use of vacuum coating. Alternatively, one skilled in the art having the benefit of the present disclosure will recognize that the active materials may be blended together and delivered as a concentrated source of activity or blended with an inert carrier and then delivered to the location where finished feed is formed using the remaining components of a complete nutritional diet. The concentrated source may be prepared as a dry meal, a liquid blend, a briquette, a pellet, a crumble or other similar feed form. In addition, the active ingredients of the invention may be applied through an oil or similar material used for top coating of the animal feed.

In an aspect, the use of yeast products with a substituted glucosamine polymer, whole or fractions include all single cell masses for example Pichia, Saccharomyces, E. coli, Corynebacterium, etc., may be used in conjunction with or independent of botanical products such as crude or purified plant extracts from peppers (piperine, Capsicum, capsaicin, etc.) or celery etc.

Those having skill in the art, with the knowledge gained from the present disclosure, will recognize that various changes can be made to the disclosed processes in attaining these and other advantages, without departing from the scope of the present disclosure. As such, it should be understood that the features of the disclosure are susceptible to modifications and/or substitutions. The specific embodiments illustrated and described herein are for illustrative purposes only, and not limiting of the invention as set forth in the appended claims.

1. A method of preventing/treating ectoparasite infections in fish, the method comprising:
mixing a glucosamine containing product with a fish feed ingredient, thus producing a fish food; and
feeding the fish food to the fish such that the ectoparasite infection is treated, reduced or prevented in the fish.

2. The method of claim 1, wherein the glucosamine containing product is a microbial biomass.

3. The method of claim 1, wherein the glucosamine containing product is a glucosamine polymer, a substituted glucosamine, or a combination thereof.

4. The method of claim 1, wherein the microbial biomass is chosen from at least one of a Pichia origin, a Saccharomyces origin, an E. coli origin, or a Corynebacteria origin.

5. The method of claim 1, wherein the feeding the fish food to the fish is for a period of at least six weeks.

6. The method of claim 1, wherein the ectoparasite is sea lice.

7. The method of claim 1, wherein the fish is salmon.

8. A method of improving health or growth in fish, or reducing the severity of ectoparasite infection, the method comprising: mixing a botanical plant extract selected for content of a lactone with a fish feed ingredient, thus producing a fish food; and feeding the fish food to the fish such that the ectoparasite infection is treated, reduced, or prevented in the fish.

9. The method of claim 8, wherein the lactone is a sesquiterpene lactone.

10. The method of claim 8, wherein the botanical plant extract contains a lactone from at least one of the germanocrolide, guianolide or phthalide lactone groups.

11. The method of claim 8, wherein the botanical plant extract source of lactone is from at least one of the botanical family groups Apiaceae, Fabaceae, Solanaceae, Asteraceae or Zingeberaceae.

12. The method of claim 8, wherein the botanical plant extract is a Capsaicin or capsaicinoid containing product.

13. A method of preventing and/or treating ectoparasite infections in fish comprises:
(a) mixing a capsaicin or capsaicinoid containing product, an essential oil, or a combination thereof with at least one fish feed ingredient, thus producing a fish feed; and
(b) feeding the fish feed to the fish such that a ectoparasite infection is treated, reduced, or prevented in the fish.

14. The method of claim 13, further comprising mixing a glucosamine containing product with the fish feed.

15. The method of claim 14, wherein the glucosamine containing product comprises a microbial biomass chosen from at least one of a Pichia origin, a Saccharomyces origin, an E. coli origin, or a Corynebacteria origin.

16. The method of claim 13, wherein the essential oil has at least one of a germanocrolide, guianolide or phthalide lactone.

17. The method of claim 13, wherein the microbial biomass is of a Pichia origin.

18. The method of claim 13, wherein the feeding the fish feed to the fish is for a period of at least six weeks.

19. The method of claim 1, wherein the fish feed comprises 0.0002-0.002% by weight capsaicinoids, 0.001-0.01% by weight an essential oil, 0.2-1.0% by weight a cell mass providing 0.001-0.01% by weight glucosamine, and the remainder a fish feed ingredient.

20. The fish feed composition of claim 19, wherein the cell mass is chosen from at least one of Pichia origin, a Saccharomyces origin, an E. coli origin, or a Corynebacteria origin.

21-23. (canceled)
